(19) United States
(12) Patent Application Publication
(10) Pub. No.: US 2018/0104863 A1
(43) Pub. Date: Apr. 19, 2018

(54) Increased Utility Composite Tooling through Additive Manufacturing

(71) Applicant: Aurora Flight Sciences Corporation, Manassas, VA (US)

(72) Inventors: Daniel Cottrell, Manassas, VA (US); Daniel Campbell, Manassas, VA (US)

(21) Appl. No.: 15/787,899

(22) Filed: Oct. 19, 2017

Related U.S. Application Data
(60) Provisional application No. 62/410,181, filed on Oct. 19, 2016.

(51) Int. Cl. B29C 33/38; B29C 70/30; B29C 51/10; B29C 33/40; B29C 33/04; B33Y 80/00

(52) U.S. Cl. CPC B29C 33/3842; B29C 70/30; B29C 51/10; B29K 2869/00; B29C 33/04; B33Y 80/00; B29C 33/40

(57) ABSTRACT

A tooling system for fabricating a composite structure comprising a printed thermoplastic material tooling component having a non-tooling surface and a tooling surface, wherein the tooling surface defines a predetermined shape for the composite structure. The tooling system may further comprise a printed thermoplastic material tooling base structure having a plurality of non-tooling surfaces to support the printed thermoplastic material tooling component during layup or cure. The printed thermoplastic material tooling base structure may employ a support structure, such as a honeycomb support structure or a filler material.

### CROSS-REFERENCE TO RELATED APPLICATION

The present application claims the benefit under 35 U.S.C. § 119(e) of provisional patent application Ser. No. 62/410,181, filed Oct. 19, 2016, the contents of which are hereby incorporated by reference.

### TECHNICAL FIELD

The present disclosure is directed to molds and tooling, more specifically tooling for composite materials, and even more specifically, an increased utility composite tooling fabricated using additive manufacturing.

### BACKGROUND

Composite tooling, which is often used for only a few cure cycles, is typically expensive and requires a long lead time. In fact, composite tooling fabrication often results in a delivery time long enough such that it paces the overall lead-time of the project. Composite tooling can also be very heavy depending on the materials employed. Finally, existing composite tooling provides very few additional features beyond a layup surface.

Existing composite tooling, or tools, is predominantly produced using subtractive manufacturing techniques, such as multiple axis computer numeric control (CNC) machines (e.g., 3 and 5 axis CNC machines). For these tools, there is typically a compromise between speed, cost, and quality. For example, a medium density fiberboard (MDF) tool may be less expensive, but requires machining, epoxy coating, re-machining, and is limited to several cure cycles. Conversely, metallic tools do not require the additional steps of epoxy coating and can withstand long-term use, but have higher raw material costs and can take as long to produce as MDF tools. Moreover, metallic tools are more burdensome to technicians as they are harder to move and manipulate due to their weight. Laminate tools would be suitable as they match the coefficient of thermal expansion (CTE) of the materials being cured and can hold up over many cycles, however laminate tools are the most costly and have some of the longest lead times because they require production of master molds, layup, machining, epoxy coating, and re-machining. Laminate tools, which often require a backing structure for support, can also be problematic for technicians due to their weight and size.

As discussed herein, tools formed using additive manufacturing techniques, in comparison, can be produced in equal to lesser times than the above techniques, and provide a lower cost and weight while minimizing wasted material. That is, a properly designed printed thermoplastic material tool only requires the material necessary to produce the final net shape (i.e., there is no waste due to, for example, trimming). Accordingly, a need exists for a composite tooling system and method using additive manufacturing techniques, such as a printed thermoplastic material tool.

### BRIEF SUMMARY OF THE INVENTION

As set forth below, an increased utility composite laminate tool using additive manufacturing is disclosed herein.

According to a first aspect, a tooling system for fabricating a composite structure comprises: a printed thermoplastic material tool having a tooling surface and a plurality of non-tooling surfaces, wherein the tooling surface defines a predetermined shape for the composite structure, wherein the printed thermoplastic material tool comprises at least one of a manifold and a conduit to transfer fluid through at least a portion of printed thermoplastic material tool to regulate a temperature of the printed thermoplastic material or the composite structure.

According to a second aspect, a multi-component tooling system for fabricating a composite structure comprises: a printed material tooling component having a non-tooling surface and a tooling surface, wherein the tooling surface defines a shape of the composite structure; and a printed material tooling base structure supporting the printed material tooling component during layup or cure, wherein the printed material tooling base structure has a plurality of non-tooling surfaces, wherein the printed material tooling base structure is fabricated at a first resolution and the printed material tooling component is fabricated at a second resolution that is higher than the first resolution.

According to a third aspect, a tooling system for fabricating a composite structure comprises: a printed material tooling component having a non-tooling surface and a tooling surface, wherein the tooling surface defines a shape of the composite structure; and a printed material tooling base structure supporting the printed material tooling component during layup or cure, wherein the printed material tooling base structure has a plurality of non-tooling surfaces.

According to a fourth aspect, a tooling system for fabricating a composite structure comprises: a first printed material tool having a plurality of non-tooling surfaces and a first tooling surface, wherein the tooling surface defines a predetermined shape for a first portion of the printed thermoplastic material tool; and a second printed material tool having a plurality of non-tooling surfaces and a second tooling surface, wherein the second tooling surface defines a predetermined shape for a second portion of the printed thermoplastic material tool, wherein each of the first printed material tool and the second printed material tool comprises one or more indexing features to facilitate assembly of the tooling system.

According to a fifth aspect, a tooling system for fabricating a composite structure comprises a printed thermoplastic material tool having a plurality of non-tooling surfaces and a tooling surface, wherein the tooling surface defines a predetermined shape for the composite structure, wherein the printed thermoplastic material tool comprises at least one hollow space.

According to a sixth aspect, a tooling system for fabricating a composite structure comprises: a printed thermoplastic material tooling component having a non-tooling surface and a tooling surface, wherein the tooling surface defines a predetermined shape for the composite structure; and a printed thermoplastic material tooling base structure having a plurality of non-tooling surfaces, wherein the printed thermoplastic material tooling base structure is configured to support the printed thermoplastic material tooling component during layup or cure.

In certain aspects, at least one of said plurality of non-tooling surfaces is shaped to define a valley, thereby decreasing material usage and weight of the printed thermoplastic material tool.

In certain aspects, the printed thermoplastic material tool is fabricated using at least two vertical resolutions.

In certain aspects, the at least two vertical resolutions include a first vertical resolution and a second vertical resolution that is higher than the first vertical resolution, wherein the tooling surface is printed at said second vertical resolution.

In certain aspects, the printed thermoplastic material tool comprises one or more embedded thermometers.

In certain aspects, the one or more embedded thermometers are embedded adjacent said tooling surface.

In certain aspects, the temperature of said printed material is regulated via said manifold or conduit based at least in part on measurements from said one or more embedded thermometers.

In certain aspects, the multi-component tooling system includes an indexing feature to facilitate assembly of the tooling system.

In certain aspects, the first resolution is a first vertical resolution and the second resolution is a second vertical resolution.

In certain aspects, the at least one hollow space is a manifold or conduit to transfer fluid through at least a portion of said single piece tool.

In certain aspects, the at least one hollow space is a conduit for vacuum distribution.

In certain aspects, the fluid is configured to regulate a temperature of said printed thermoplastic material. The fluid may be, for example, a gas (e.g., air) or a liquid (e.g., water).

In certain aspects, the printed thermoplastic material tool is fabricated as a single component using additive manufacturing techniques.

In certain aspects, at least one of said plurality of non-tooling surfaces is shaped to define a valley, thereby decreasing material usage and weight of the printed thermoplastic material tool.

In certain aspects, the at least one hollow space comprises an electronic device, such as a thermometer.

In certain aspects, the printed thermoplastic material tooling base structure comprises a honeycomb support structure shaped to support the non-tooling surface of the printed thermoplastic material tooling component.

In certain aspects, the honeycomb support structure is sized and shaped to correspond to the size and shape of the non-tooling surface of the printed thermoplastic material tooling component.

In certain aspects, the printed thermoplastic material tooling base structure comprises a filler material to support the non-tooling surface of the printed thermoplastic material tooling component. The filler material may be, for example, a foam material.

### BRIEF DESCRIPTION OF THE FIGURES

These and other advantages of the present disclosure will be readily understood with the reference to the following specifications and attached drawings wherein:

FIGS. 1a and 1b illustrate an exemplary single piece tool system.

FIG. 1c illustrates a cut away view of the single piece tool system of FIGS. 1a and 1b.

FIG. 2a illustrates an exemplary multi-piece tool system.

FIG. 2b illustrates an exemplary multi-piece tool system with the tooling base structure removed.

FIG. 3a illustrates an exemplary tooling base structure having a honeycomb structure for use in a multi-piece tool system.

FIG. 3b illustrates an exemplary component tool for use in a multi-piece tool system.

FIG. 3c illustrates an exemplary multi-piece tool system during vacuum bagging.

FIG. 3d illustrates the component tool of FIG. 3b with a corresponding composite structure.

FIG. 4 illustrates another exemplary multi-piece tool system having a plurality of tool pieces that are combined to yield a component to correspond to the shape of a tooling component.

### DETAILED DESCRIPTION OF THE INVENTION

Preferred embodiments of the present disclosure will be described hereinbelow with reference to the accompanying drawings. In the following description, certain well-known functions or constructions are not described in detail since they would obscure the disclosure in unnecessary detail. The figures are not necessarily to scale, emphasis instead being placed upon illustrating the principles of the devices, systems, and methods described herein. For this application, the following terms and definitions shall apply:

The terms “about” and “approximately,” when used to modify or describe a value (or range of values), mean reasonably close to that value or range of values. Thus, the embodiments described herein are not limited to only the recited values and ranges of values, but rather should include reasonable workable deviations.

The terms “aerial vehicle” and “aircraft” refer to a machine capable of flight, including, but not limited to, traditional aircraft and vertical takeoff and landing (VTOL) aircraft. VTOL aircraft may include both fixed-wing aircraft, rotorcraft (e.g., helicopters), and/or tilt-rotor/tilt-wing aircraft.

The term “composite material” as used herein, refers to a material comprising an additive material and a matrix material. For example, a composite material may comprise a fibrous additive material (e.g., fiberglass, glass fiber (“GF”), carbon fiber (“CF”), aramid/para-aramid synthetic fibers, etc.) and a matrix material (e.g., epoxies, polyimides, and alumina, including, without limitation, thermoplastic, polyester resin, polycarbonate thermoplastic, casting resin, polymer resin, acrylic, chemical resin). In certain aspects, the composite material may employ a metal, such as aluminum and titanium, to produce fiber metal laminate (FML) and glass laminate aluminum reinforced epoxy (GLARE). Further, composite materials may include hybrid composite materials, which are achieved via the addition of some complementary materials (e.g., two or more fiber materials) to the basic fiber/epoxy matrix.

The term “composite laminates” as used herein, refers to a type of composite material assembled from layers (i.e., a “ply”) of additive material and a matrix material.

The term “composite structure” as used herein, refers to structures or components fabricated, at least in part, using a composite material, including, without limitation, composite laminates.

The term “exemplary” means serving as a non-limiting example, instance, or illustration. As utilized herein, the terms “e.g.” and “for example” set off lists of one or more non-limiting examples, instances, or illustrations.

The term “tool” and “tooling” as used herein refers to a mold or similar structure used to form a structure, such as a composite structure fabricated from a composite material.

Disclosed herein is an increased utility tool fabricated using additive manufacturing techniques to yield a printed thermoplastic material tool. Additive manufactured tooling is beneficial to composite material tooling in that it provides the ability to rapidly produce and iterate printed thermoplastic material tools at a minimal cost. That is, additive manufacturing reduces lead-time and monetary costs for tooling, while allowing for features not possible with traditional subtractive manufacturing, i.e., the successively cutting material away from a solid block of material. For rapid prototyping, reducing the lead-time and cost facilitates aggressive schedules and budgets, while also making iteration less costly. As a result, for production parts, this reduces master mold costs and lead times, while providing relatively inexpensive disposable tooling and trim fixtures. Indeed, once the tool design is finalized, additive manufacturing techniques may be employed to produce the printed thermoplastic material tool, whether the printed thermoplastic material tool is needed in small or large quantities.

Additive manufacturing processes also allow for implementation of unique features into the printed thermoplastic material tool, which are not possible with traditional subtractive manufacturing methods. For example, internal pathways and complex structures can be realized in the tool design to increase functionality thereof. For a printed thermoplastic material tool, integrated features, including conduits to embed thermocouples, may be provided under (and/or adjacent to) the tooling surface without affecting the composite structure itself. Indeed, passages printed into the printed thermoplastic material tool can be used to more quickly and evenly heat or cool the printed thermoplastic material tool as needed, thus more quickly and evenly heat or cool the composite part as needed. Further, indexing features can be easily added to tool designs and printed to facilitate the assembly of multi-piece printed thermoplastic material tools as well as to aid in final trim and drill.

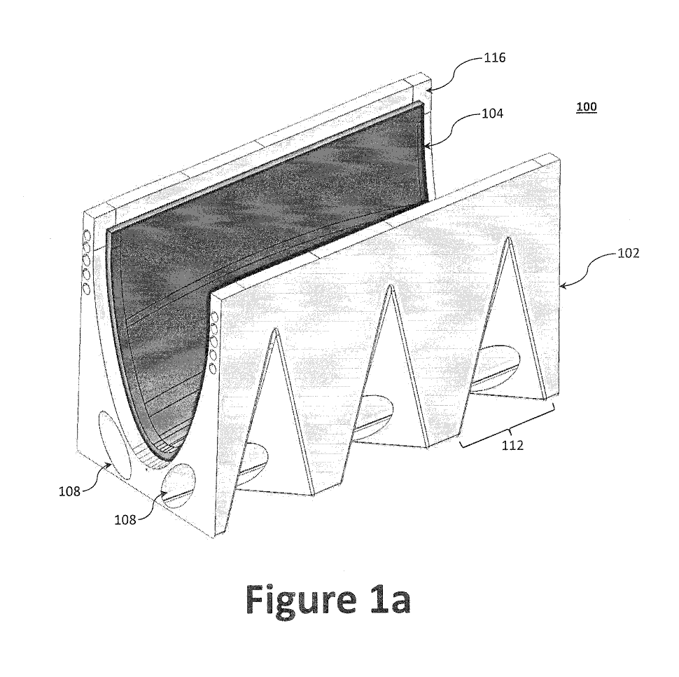

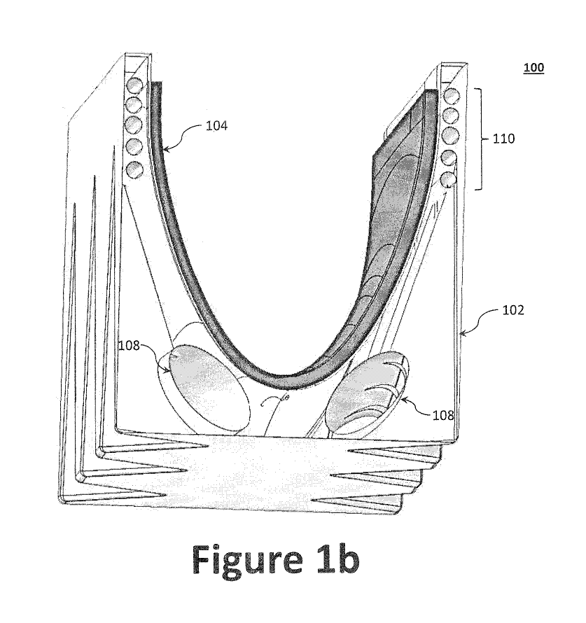

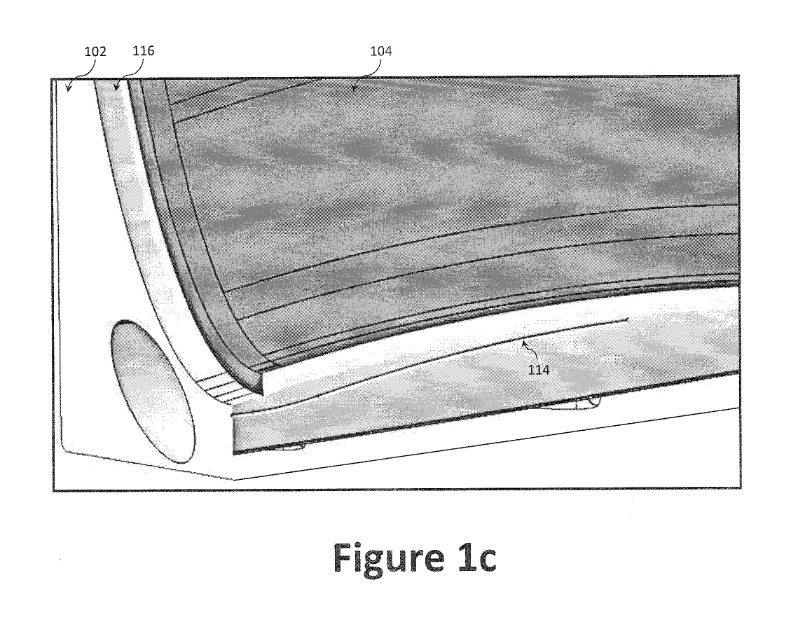

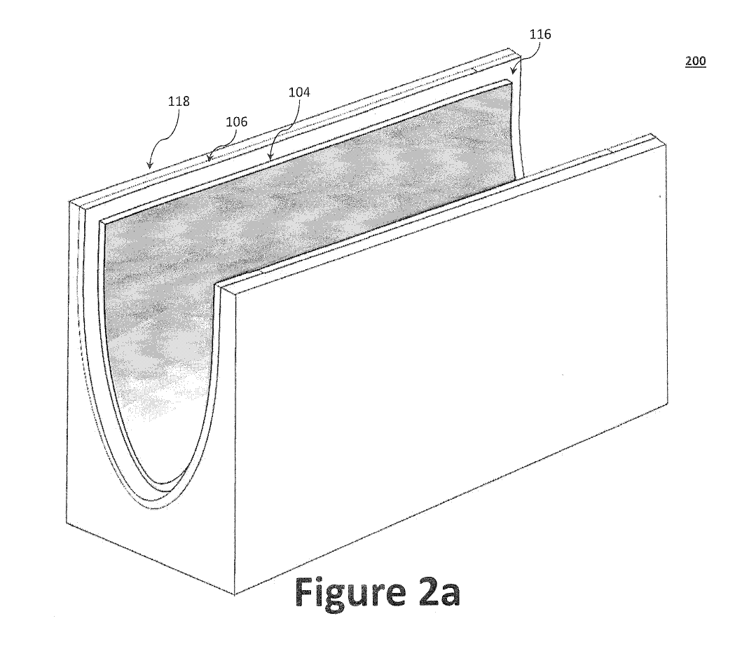

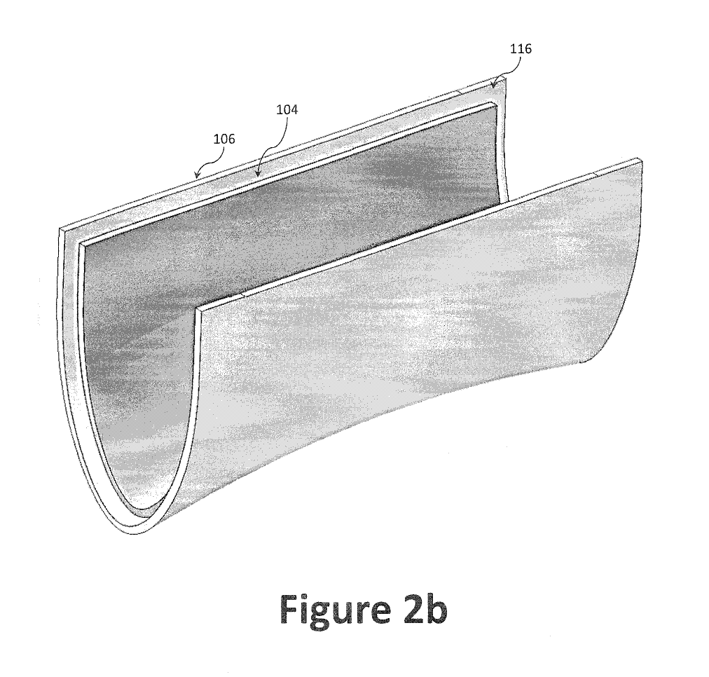

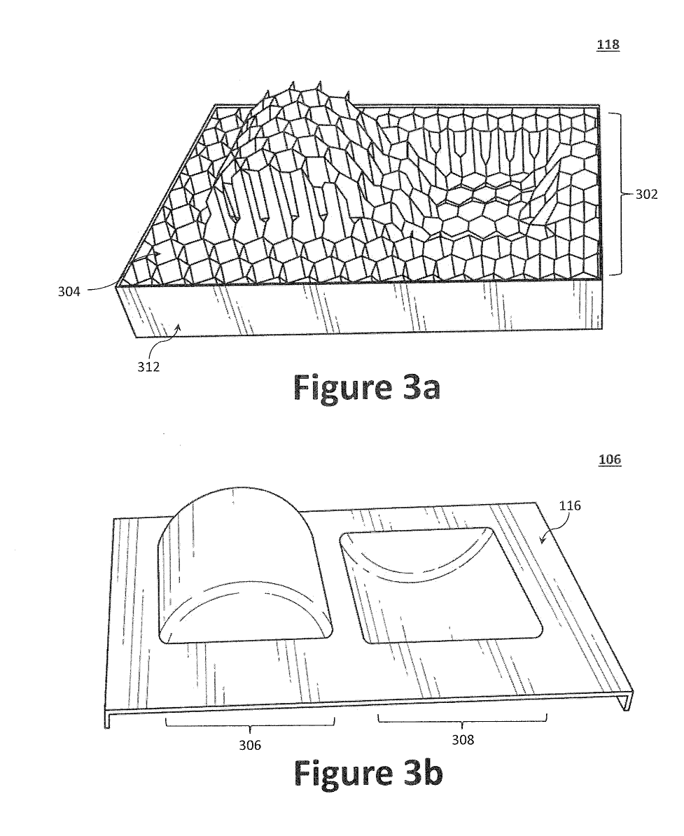

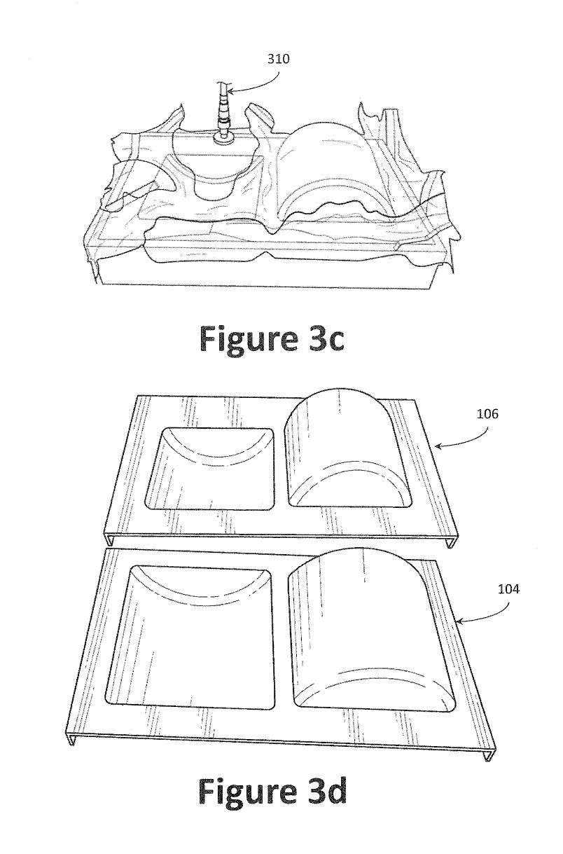

FIGS. 1a through 1c and FIG. 2 illustrate two exemplary tool designs. As will be discussed, the single piece tool system 100 of FIGS. 1a through 1c incorporates additional features, which may assist in the layup and cure of a composite structure. The multi-piece tool system 200 of FIG. 2, conversely, is simplified in that it includes fewer features, but requires substantially less structural material and is therefore more quickly fabricated and at a lower cost. While the various figures illustrate a female tool with an outer mold line (OML) structure, the additive manufactured tooling and techniques discloses herein may be used to generate a printed thermoplastic material tool of virtually any size and shape, including an inner mold line (IML) tool. For example, FIGS. 3a through 3d illustrate an example multi-piece tool 300 having both a male portion 306 and a female portion 308.

A printed thermoplastic material tool, whether a single piece tool system 100 or a multi-piece tool system 200, may be printed through one or more additive manufacturing techniques, also referred to as three-dimensional (3D) printing. Additive manufacturing generally refers to processes used to fabricate a 3D object in which successive layers of material (e.g., thermoplastic) are formed under computer control to create the 3D object (e.g., a printed material tool, such as a printed thermoplastic material tool), which can be of almost any shape or geometry. The printed thermoplastic material tool may be produced from digital model data or another electronic data source such as an additive manufacturing file (AMF) file. In other words, the designer can create the design model for a printed thermoplastic material tool in a digital space using a modeling program (e.g., a computer-aided design (CAD) package). An advantage of design model created with CAD (as opposed to scanning) is the reduction in errors, which can be corrected before printing the 3D object, thereby allowing verification in the design of the object before it is printed.

Additive manufacturing techniques print objects in three dimensions, therefore both the minimum feature size (i.e., resolution) of the XY plane (horizontal resolution) and the layer height in Z-axis (vertical resolution) are considered in overall printer resolution. Horizontal resolution is the smallest movement the printer's extruder can make within a layer on the X and the Y axis, while vertical resolution is the minimal thickness of a layer that the printer produces in one pass. Printer resolution describes layer thickness and X-Y resolution in dots per inch (dpi) or micrometers (μall). The particles (3D dots) in the horizontal resolution are around 50 to 100 μm (510 to 250 DPI) in diameter. Typical layer thickness is around (vertical resolution) 100 μm (250 DPI), although the layers may be as thin as 16 μm (1,600 DPI). The smaller the particles, the higher the horizontal resolution (i.e., higher the details the printer produces). Similarly, the smaller the layer thickness in Z-axis, the higher the vertical resolution (i.e., the smoother the printed surface will be). The printing process in a higher vertical resolution printing, however, will take longer to produce finer layers as the printer has to produce more layers. Accordingly, the printed thermoplastic material tool can be printed with great accuracy and with numerous details, which is particularly advantageous to the tooling surface that defines the surface of the composite structure.

Turning to FIGS. 1a through 1c, a single piece tool system 100 is illustrated having a single piece tool 102 and a composite structure 104 (e.g., a composite laminate component). The single piece tool 102 may be fabricated from a printed thermoplastic material, such a high-performance fused deposition modeling (FDM) thermoplastic or polycarbonate. Suitable printed thermoplastic materials include, for example, polyetherimide (PEI), which offers excellent strength, thermal stability, and the ability to withstand autoclaving (high pressure and temperature). Polycarbonate is a suitable material for printed thermoplastic material tools due to its lower cost and ability to withstand the required cure temperatures (e.g., 200° F. to 400° F., or about 250° F.); however other materials are contemplated as material selection is driven by the cure temperature for a given composite components. Therefore, other materials with higher, or lower, temperature tolerances may be employed depending on the application (e.g., the type of composite material).

The composite structure 104 may be one of any number of composite materials. Suitable composite materials for aerial vehicles, include, without limitation, 977-3 resin and IM7/977-3 pre-preg available from Cytec Industries, which is a toughened epoxy resin with 350° Fahrenheit (F) (177° C.) dry and 270° F. (132° C.) wet service capability. Accordingly, the single piece tool 102 is capable of withstanding multiple cure cycles at, for example, at least 350° F. and a pressure of at least 90 pounds per square inch (PSI). As can be appreciated by those of ordinary skill in the art, the term pre-preg refers to “pre-impregnated” composite fibers where a material, such as epoxy is already present, in the composite fibers. Initially, pre-preg is flexible and sticky, but becomes hard and stiff once it has been heated (i.e., during the curing process) and cooled.

As illustrated, the single piece tool 102 may be a unitary structure with a plurality of internal pathways, channels, or other hollow spaces, such as manifolds 108 and conduits 110, 114. Specifically, two internal manifolds 108 are illustrated running lengthwise along the base (i.e., lower portion) of the single piece tool 102, while ten conduits 110 (five on each side) are illustrated running lengthwise along the upper sides of the single piece tool 102. The internal pathways, channels, and/or other hollow spaces are preferably created during formation of the design model for the printed thermoplastic material tool via a modeling program. Therefore, once the design model for a given printed thermoplastic material tool is created, iterations may be readily generated.

The internal manifolds 108 and conduits 110 are provided within the single piece tool 102 and may be used to provide a number of functions. For example, the internal manifolds 108 and conduits 110 may allow for the transfer of hot and/or cold fluid (e.g., a gas or liquid); thereby more evenly heating or cooling the single piece tool 102 from within the structure. The hot and/or cold fluid may be provided in either a gaseous or a liquid form. For example, suitable gasses may include air (i.e., a mixture of oxygen, nitrogen, and other gases) and Freon, while suitable liquids may include water, glycols, deionized water, dielectric fluids (e.g., Fluorinert, polyalphaolefin), etc. That is, the internal manifolds 108 and conduits 110 may be used to regulate the temperature of the single piece tool 102 at a predetermined value (or within a predetermined temperature range) to mitigate warping of the single piece tool 102, to mitigate CTE expansion, and to mitigate degradation of the single piece tool 102 over multiple cure cycles. As can be appreciated, the temperature may be regulated to ensure that the single piece tool 102 is not damaged due to overheating. More importantly, however, the temperature may be regulated to ensure that the composite structure 104 is cured at the appropriate temperature. For example, the temperature of the composite structure 104 may be uniform in both the planar dimension and thickness. Accordingly, the internal passages may be configured to control the temperature of the composite part during the cure process.

Additional internal pathways, channels, and/or other hollow spaces, may be provided within the single piece tool 102 to allow for installation of embedded instrumentation, vacuum distribution, conductors, tubing, electronic devices, etc. For example, a plurality of electronic devices (e.g., sensors, pressure sensors, thermometers, or other monitoring devices) may be provided throughout the single piece tool 102. As illustrated in FIG. 1c, for example, one or more small conduits 114 (i.e., hollow spaces) may be positioned just below and adjacent the tooling surface 116. A can be appreciated; the tooling surface 116 refers to the portion (e.g., surface or surfaces) of the single piece tool 102 (or tooling component 106) that contact(s) the composite structure 104 during layup and/or cure of the composite structure 104. The tooling surface 116 is typically shaped to define a predetermined shape for the composite structure 104 to be formed.

The one or more small conduits 114 may include electronics, or simply provide for fluid flow. For example, a plurality of thermometers may be distributed throughout the single piece tool 102 and used by a computer to generate a heat map for the single piece tool 102, thereby ensuring that a desired temperature or temperature profile is maintained. The heat map may be used to identify hot/cold spots, allocate, and adjust heating and cooling allocation to the single piece tool 102 via the internal manifolds 108 and conduits 110, thereby maintaining the desired temperature distribution to ensure that the composite structure 104 cures according to manufacturing specifications. The desired temperature distribution may be evenly distributed or targeted (e.g., one or more regions may be intentionally maintained/regulated at a different temperature). Similarly, pressure sensors may be employed and used by a computer to generate a pressure map, thereby maintaining the desired pressure distribution (e.g., when under a vacuum).

The non-tooling surfaces (i.e., surfaces other than the tooling surface 116) of the single piece tool 102 are not used to define the shape of the composite structure 104, but rather provide structural integrity to the single piece tool 102. Therefore, the surface contour or shape of the non-tooling surfaces is less significant to the composite structure 104. Accordingly, the non-tooling surfaces may be shaped to define a plurality of valleys 112 (e.g., an internal angle, carved out portions, other recesses, etc.) along outer surface of the non-tooling surfaces. The valleys 112 serve to decrease material usage and weight of the single piece tool 102, which reduces costs and printing time of the single piece tool 102. The valleys 112 may also serve to regulate temperature of the single piece tool 102 by maintaining a substantially distributed volume of material adjacent the composite structure 104. That is, a large volume of material is slower to reach temperature as compared to a smaller volume of the same material. Therefore, mitigating concentration of large material volumes can result in a more even heat profile. In certain aspects, the single piece tool 102 may be generated with internal voids (e.g., air bubbles, voids, or pockets) in regions where structure integrity of the single piece tool 102 can be compromised to reduce weight, material use, and print time of single piece tool 102.

The tooling surface 116 of the single piece tool 102 may be finished (shaped) to produce an aerospace grade surface finish, or other finish as desired for a given composite structure. For example, the tooling surface 116 may be prepared for layup of the composite structure 104 through one or more techniques, including sanding (whether by hand or machine), surface film, or vacuum forming polymer sheets. In other aspects, the tooling surface 116 may be finished with polytetrafluoroethylene (PTFE) tape (e.g., Teflon tape) to ensure release post cure, while joints may be covered with thin sheets of release film. Although the surface finish is generally more porous when sanded compared to PTFE tape, the composite structure 104 will nevertheless release from the tool. The single piece tool 102 may further incorporate additional features, such as indexing components to assemble multi-piece tools (if necessary), indexing for trim tools, and features that reduce print material or decrease print time. In certain aspects, the tooling surface 116 may be provided with one or more textures, shapes, insignias, etc. during the printing process of the composite structure 104. One or more mold release agents, cleaners, and sealers may be employed, such as those available from Henkel Corporation under the Frekote® product line.

Turning to FIGS. 2a and 2b, a multi-piece tool system 200 is illustrated having a tooling component 106, a tooling base structure 118, and a composite structure 104 (e.g., a composite laminate component). The multi-piece tool system 200 may embody, as desired, one or more of the features described with regard to the single piece tool system 100. For clarity, FIG. 2b illustrates the multi-piece tool system 200 with the tooling base structure 118 removed, leaving just the tooling component 106 and the composite structure 104. As illustrated, the tooling component 106 is a generally thin shell (e.g., a shell shape) that defines the tooling surface 116 using minimal print material. Because the tooling component 106 is a thin shell, the tooling component 106 may require additional structural support to mitigate distortion during layup and/or cure of the composite structure 104, which is provided by, for instance, the honeycomb support structure 302 of the tooling base structure 118. Indeed, a function of the honeycomb support structure 302 is to support the tooling component 106 so that it is easier to layup the composite material onto the tooling component 106 to create the composite structure 104. The honeycomb support structure 302, however, can also provide support to the tooling component 106 and the composite structure 104 during the curing process. The thin shell may be, for example, 0.1 to 1.0 inches thick, more preferably, 0.25 to 0.75 inches thick, and most preferably about 0.5 inches thick, fully dense.

Like the single piece tool 102, each of the tooling component 106 and the tooling base structure 118 may be fabricated from a printed thermoplastic material and in substantially the same manner. Accordingly, the multi-piece tool system 200 should be similarly capable of withstanding multiple cure cycles. The tooling base structure 118, which supports the tooling component 106, may be fabricated as an egg crate structure to reduce weight. For example, as will be described in connection with FIGS. 3a through 3d, the tooling base structure 118 may include a honeycomb support structure 302 that substantially supports the underside of the tooling component 106.

While the tooling component 106 is relatively thin, tool maintenance and repair remain possible, even in the event of damage to the tooling component 106. For example, a break or crack in a printed thermoplastic material tool (e.g., a tool printed from polycarbonate) used for multiple layups may be repaired using an epoxy (e.g., an aerospace epoxy). A suitable aerospace epoxy would include, for example, Hysol 9394, which is available from Henkel AG & Co. and provides excellent strength above 400° F./204° C.

An advantage of the multi-piece tool system 200 is that the tooling base structure 118 can serve as the primary structure while additional pieces, such as tooling component 106, would provide the layup surface (i.e., tooling surface). As component tools 106 are extremely inexpensive relative to other components, even in a worst-case scenario where the tooling component 106 is discarded after one or two cures, the associated cost would still be less than having provided a single piece tool that may require routine maintenance/repair. Moreover, because printing a component in higher resolution takes longer than lower resolution, the components of the multi-piece tool system 200 may be printed at different resolutions. Components having a tooling surface 116 may be printed at a higher resolution because the tooling surface 116 contacts, and defines the shape/surface of, the composite structure 104. Components without a tooling surface 116, on the other hand, may be printed at a lower resolution to expedite printing time because they do not affect the quality or finish of the composite structure 104, but rather serve to provide structural support. Similar techniques may be applied to the single piece tool system 100. For example, the support portions of the single piece tool 102 may be printed at a lower resolution, while the tooling surface 116 of the single piece tool 102, or regions/subcomponents including and/or adjacent the tooling surface 116, may be printed at a higher resolution.

The multi-piece tool system 200 is designed to require substantially less material than the single piece tool 102, therefore reducing material cost and print time. As a result, incorporating internal pathways, channels, and/or other hollow spaces may be more challenging depending on the thicknesses of the material in a given area of the multi-piece tool system 200. Therefore, it is contemplated that one or more regions of the multi-piece tool system 200 may be designed to accommodate one or more internal pathways, channels, and/or other hollow spaces. For example, the tooling component 106 may fabricated with an overall greater thickness, in whole or in part, than would otherwise be required in order to accommodate, for instance, one or more conduits 110. The multi-piece tool system 200 may further incorporate additional features, such as indexing components to assemble multi-piece tools (if necessary), indexing for trim tools, and features that reduce print material or decrease print time.

Turning to FIGS. 3a through 3d, an example layup and cure process is illustrated using a multi-piece tool system 300, akin to the multi-piece tool system 200 of FIGS. 2a and 2b. Specifically, FIG. 3a illustrates a top perspective view of a tooling base structure 118. As illustrated, the tooling base structure 118 generally comprises a base housing 312 (e.g., a box or pan shaped housing) and a honeycomb support structure 302 within the base housing 312. The honeycomb support structure 302 has a geometry of a honeycomb to minimize the amount of material needed to achieve minimal weight and minimal material cost. The geometry of honeycomb support structure 302, the style of which can vary widely, generally comprises an array of hollow cells 304 formed between thin vertical walls of material. As illustrated, the hollow cells 304 may be columnar and hexagonal in shape, although other shapes are contemplated. As illustrated, the surface of honeycomb support structure 302 is sized and shaped to correspond to the shape of the tooling component 106, thereby providing substantially even support to the underside of the tooling component 106 during layup and cure.

In certain aspects, the honeycomb support structure 302 may be interchangeable, thereby enabling the operator to reuse the base housing 312 with other honeycomb support structures. For example, the honeycomb support structure 302 may be printed as a separate component and sized to fit in a standard base housing 312. In certain aspects, the honeycomb support structure 302 may be replaced with a filler material (e.g., a foam material, such as a two-part foam material). For example, a two-part foam may be injected into the base housing 312, which would then expand to fill the void defined by the base housing 312 and underside of the tooling component 106. In yet another example, one or more of the cells 304 of the honeycomb support structure 302 may be filled with a filler material to provide added strength as desired.

As illustrated in FIG. 3b, the example tooling component 106 may be configured with both a male portion 306 and a female portion 308. FIG. 3c illustrates the multi-piece tool system 300 during vacuum bagging, although the same vacuum bagging process may be used with the single piece tool system 100. As illustrated, a vacuum bagging assembly may comprise one or more vacuum ports 310, a reader port, and a breather fabric, which may be laid down around the composite structure 104 as well as paths to the vacuum ports 310. The final assembly may then be bagged and put under vacuum to apply pressure during the infusion/cure processes. The vacuum bag may then be placed into an oven, which heats the material, causing the resin in the resin film and/or pre-preg to change from sticky and soft to hard and stiff. Providing pleats in the bag can enable uniform distribution (i.e., to avoid bridging on the bag) of the vacuum pressure on the tooling component 106 and the composite structure 104. The use of breather fabric provides air pathways to the vacuum ports 310 to create as much pressure as possible on and around the part without allowing the back to choke off sections of the layup. FIG. 3d illustrates the tooling component 106 alongside a finished, corresponding composite structure 104.

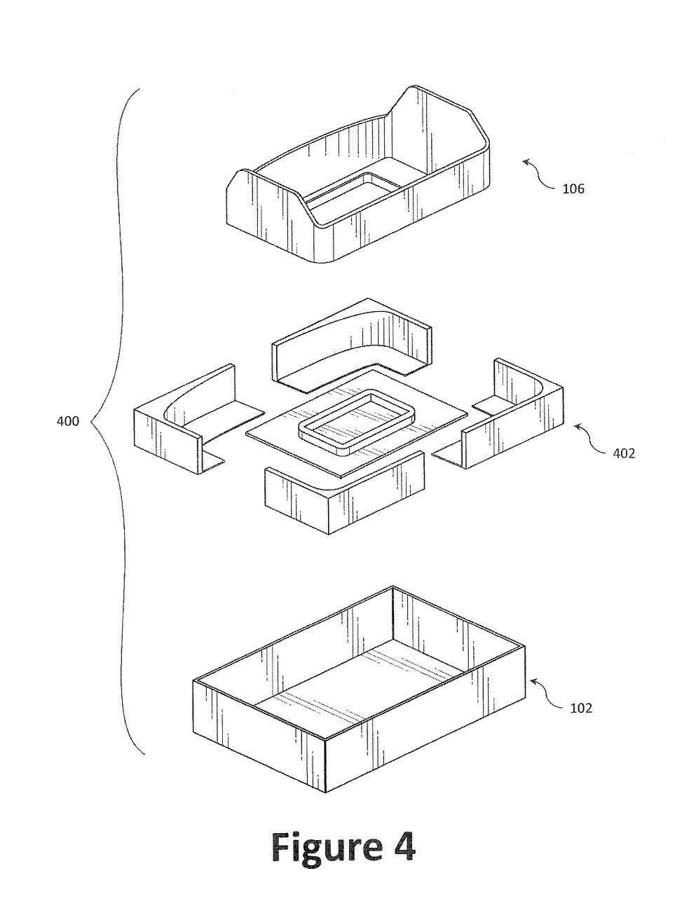

Another example multi-piece tool system 400 is illustrated in FIG. 4. As illustrated, the multi-piece tool system 400 generally comprises a base housing 312, a tooling component 106, and plurality of tool pieces 402 that are combined to yield a component that sized and shaped to correspond to the shape of the tooling component 106. Specifically, the plurality of tool pieces 402 are assembled to fit in the base housing 312. The tooling component 106 (e.g., skin piece) is positioned over the assembly of tool pieces 402 to be used as the layup surface. Here, the base housing 312 is used as the indexing feature to arrange the tool pieces 402. As discussed above, the tooling component 106 can be printed at a higher resolution and disposed of more frequently than the other printed parts.

To validate the above-described additive manufacturing tooling techniques, a set of large printed tool components that together form a printed thermoplastic material tool of approximately 9×2×2 feet were created to produce a composite structure (i.e., a fairing) for an aircraft. The printed thermoplastic material tool was printed from polycarbonate material to allow for 250° F. cures in an out-of-autoclave cure process utilizing a fiberglass pre-preg. The printed thermoplastic material tool was composed of seven unique parts, three of which were designed to be removable post cure as the composite structure would otherwise be trapped on the tooling. Some printed thermoplastic material tool parts were printed with a sparse fill (e.g., a single piece tool system 100) and after the print was complete required no post processing to maintain their shape when under vacuum. Other printed thermoplastic material tool parts were printed as large shells (e.g., a multi-piece tool system 200) as this greatly reduced print time (i.e., by half), however post processing was required in which the shells were filled with a two-part foam so that the parts could withstand the vacuum pressure during cure. Both methods proved successful, each with their own benefits and detriments, as discussed above.

While the single piece tool and multi-piece tool are described in connection with composite material tooling, the various disclosed techniques may be used in other molding processes, including, without limitation, thermoforming (including vacuum forming), blow molding, compression molding, injection molding, matrix molding, etc. Further, while the present invention has been described with respect to what is presently considered the preferred embodiments, it is to be understood that the invention is not limited to the disclosed embodiments. To the contrary, the invention is intended to cover various modifications and equivalent arrangements included within the spirit and scope of the appended claims. The scope of the following claims is to be accorded the broadest interpretation to encompass all such modifications and equivalent structures and functions.

All documents cited herein, including journal articles or abstracts, published or corresponding U.S. or foreign patent applications, issued or foreign patents, or any other documents, are each entirely incorporated by reference herein, including all data, tables, figures, and text presented in the cited documents.

What is claimed is:

1. A tooling system for fabricating a composite structure, the tooling system comprising:
a printed thermoplastic material tool having a tooling surface and a plurality of non-tooling surfaces,
wherein the tooling surface defines a predetermined shape for the composite structure,
wherein the printed thermoplastic material tool comprises at least one of a manifold and a conduit to transfer fluid through at least a portion of printed thermoplastic material tool to regulate a temperature of the printed thermoplastic material or the composite structure.

2. The tooling system of claim 1, wherein at least one of said plurality of non-tooling surfaces is shaped to define a valley.

3. The tooling system of claim 1, wherein the printed thermoplastic material tool is fabricated using at least two vertical resolutions.

4. The tooling system of claim 3, wherein the at least two vertical resolutions comprise a first vertical resolution and a second vertical resolution that is higher than the first vertical resolution, wherein the tooling surface is printed at said second vertical resolution.

5. The tooling system of claim 1, wherein the printed thermoplastic material tool comprises one or more embedded thermometers.

6. The tooling system of claim 5, wherein the one or more embedded thermometers are embedded adjacent the tooling surface.

7. The tooling system of claim 6, wherein a temperature of at least one of the printed thermoplastic material tool and the composite structure is regulated via the manifold or the conduit based at least in part on measurements from said one or more embedded thermometers.

8. A multi-component tooling system for fabricating a composite structure, the multi-component tooling system comprising:
a printed material tooling component having a non-tooling surface and a tooling surface, wherein the tooling surface defines a shape of the composite structure; and
a printed material tooling base structure supporting the printed material tooling component during layup or cure, wherein the printed material tooling base structure has a plurality of non-tooling surfaces,
wherein the printed material tooling base structure is fabricated at a first resolution and the printed material tooling component is fabricated at a second resolution that is higher than the first resolution.

9. The multi-component tooling system of claim 8, wherein the multi-component tooling system includes an indexing feature to facilitate assembly of the tooling system.

10. The multi-component tooling system of claim 8, wherein the first resolution is a first vertical resolution and the second resolution is a second vertical resolution.

11. The multi-component tooling system of claim 8, wherein the first resolution is a first horizontal resolution and the second resolution is a second horizontal resolution.

12. The multi-component tooling system of claim 8, wherein the printed material tooling component has a shell shape.

13. The multi-component tooling system of claim 12, wherein the printed material tooling component is between 0.25 to 0.75 inches in thickness.

14. The multi-component tooling system of claim 12, wherein the printed material tooling component and the printed material tooling base structure are fabricated using a thermoplastic.

15. The multi-component tooling system of claim 14, wherein at least one of the printed material tooling component and the printed material tooling base structure is fabricated using an additive manufacturing technique.

16. A tooling system for fabricating a composite structure, the tooling system comprising:
a printed material tooling component having a non-tooling surface and a tooling surface, wherein the tooling surface defines a shape of the composite structure; and
a printed material tooling base structure supporting the printed material tooling component during layup or cure, wherein the printed material tooling base structure has a plurality of non-tooling surfaces.

17. The tooling system of claim 16, wherein the printed material tooling base structure comprises a honeycomb support structure shaped to support the non-tooling surface of the printed material tooling component.

18. The tooling system of claim 16, wherein the printed material tooling base structure comprises a filler material to support the non-tooling surface of the printed material tooling component.

19. The tooling system of claim 18, wherein the filler material is a foam material.

20. A tooling system for fabricating a composite structure, the tooling system comprising:
a first printed material tool having a plurality of non-tooling surfaces and a first tooling surface, wherein the tooling surface defines a predetermined shape for a first portion of the printed thermoplastic material tool; and
a second printed material tool having a plurality of non-tooling surfaces and a second tooling surface, wherein the second tooling surface defines a predetermined shape for a second portion of the printed thermoplastic material tool,
wherein each of the first printed material tool and the second printed material tool comprises one or more indexing features to facilitate assembly of the tooling system.

21. The tooling system of claim 20, wherein the first printed material tool comprises at least one hollow space.

22. The tooling system of claim 21, wherein the at least one hollow space is configured to transfer fluid through at least a portion of the printed thermoplastic material tool.

23. The tooling system of claim 21, wherein the at least one hollow space is a conduit for vacuum distribution.

24. The tooling system of claim 22, wherein the at least one hollow space is configured to regulate a temperature of said printed thermoplastic material tool by transferring the fluid.
